(19) United States
(12) Patent Application Publication
(10) Pub. No.: US 2015/0109236 A1
(43) Pub. Date: Apr. 23, 2015

(54) TOUCH DISPLAY PANEL

(71) Applicant: Novatek Microelectronics Corp., Hsinchu (TW)

(72) Inventors: Tien-Nan Wang, Taichung City (TW); Chih-Chang Lai, Taichung City (TW)

(73) Assignee: Novatek Microelectronics Corp., Hsinchu (TW)

(21) Appl. No.: 14/162,777

(22) Filed: Jan. 24, 2014

(30) Foreign Application Priority Data
Oct. 21, 2013 (TW) 102137944

(51) Int. Cl. G06F 3/046

(52) U.S. Cl. CPC G06F 3/046
USPC 345/174

(57) ABSTRACT

A touch display panel is provided, and the touch display panel includes a display panel, a color filter, a touch panel, and a touching control chip. The color filter is disposed on a first surface of the display panel, and a second surface of the color filter covers a portion of the first surface of the display panel. The touch panel covers a portion of the first surface of the color filter. The touching control chip is disposed on an area of the first surface of the color filter not covered by the touch panel.

### CROSS-REFERENCE TO RELATED APPLICATION

This application claims the priority benefit of Taiwan application serial no. 102137944, filed on Oct. 21, 2013. The entirety of the above-mentioned patent application is hereby incorporated by reference herein and made a part of this specification.

### BACKGROUND OF THE INVENTION

1. Field of the Invention

The invention relates to a touch display panel.

2. Description of Related Art

With advancement in electronics techniques, a display panel provided with a touch function has become essential for current electronic products. To perform a controlling action to the display action of the display panel and the touch function, it is required to dispose a display control chip and a touching control chip in the touch display panel.

Please refer to FIG. 1. FIG. 1 is a schematic view illustrating a touch display panel of conventional techniques. A conventional touch display panel 100 includes a display panel 110, a color filter 120, a touch panel 130, a display control chip 150, and a touching control chip 170, wherein the display panel 110 may have a plurality of display pixels formed of a thin film transistor. The touch panel 130 includes a plurality of touch detecting units and the touch panel 130 covers the display panel 110. In addition, the color filter 120 covers the touch panel 130. Within the touch display panel 100, the display control chip 150 may be disposed on an area of a surface of the display panel 110 not covered by the touch panel 130. The touching control chip 170 may be connected to the display panel 110 through being connected to a flexible circuit board FPC of the display panel 110, and is electrically connected to the touch panel 130 via a conductive wire in the display panel 110 to perform a touching control action to the touch panel 130.

It is clearly shown in FIG. 1 that, within the conventional touch display panel 100, the layout of the conductive wire with respect to the display control ship 150 and the touching control chip 170 are arranged in the same area on the display panel 110, which inevitably makes it more difficult to arrange the layout. Accordingly, such layout method inevitably causes the length of the conductive wire to become longer; consequently, the noise likely to be produced due to this affects the quality of the data transmitted by the conductive wire. Moreover, the use of flexible circuit board FPC will increase the cost of products as well, which causes the products to become less competitive.

### SUMMARY OF THE INVENTION

The invention provides a touch display panel which may lower manufacturing cost.

In the invention, the touch display panel includes a display panel, a color filter, a touch panel, and a touching control chip. The display panel has a first surface; a color filter has a first surface and a second surface. The color filter is disposed on the first surface of the display panel, and the second surface of the color filter covers a portion of the first surface of the display panel. The touch panel covers a portion of the first surface of the color filter. The touching control chip is disposed in a portion of the first surface of the color filter not covered by the touch panel.

In an embodiment of the invention, the touch display panel further includes a display driving chip disposed in a portion of the first surface of the display panel not covered by the color filter.

In an embodiment of the invention, the display panel includes a plurality of display pixels, wherein the display driving chip is electrically connected to the display driving chip.

In an embodiment of the invention, the touch panel includes a plurality of touch detecting units, and the touch detecting units are connected to the touching control chip via the conductive wire.

In an embodiment of the invention, the conductive wire is disposed in the first surface of the color filter, and the conductive wire is indium tin oxide conductive wire.

In an embodiment of the invention, the touching control chip is disposed in the color filter in the manner of chip on glass.

In an embodiment of the invention, the touch display panel further includes a glass cover. The glass cover is disposed on the touch panel and covers the touch panel as well as the touching control chip.

In an embodiment of the invention, the touch display panel further includes a polarization plate and a plurality of supporting posts. The polarization plate is disposed between the glass cover and the touch panel and covers the touch plate. The supporting posts are disposed between the glass cover and the polarization plate for supporting the glass cover, wherein the sum of the height of each of the supporting posts, the height of the touch panel, and the height of the polarization plate is greater than the height of the touching control chip.

In an embodiment of the invention, the touch display panel further includes a polarization plate and an optical film. The polarization plate is disposed between the glass cover and the touch panel and covers the touch panel. The optical film is disposed between the glass cover and the polarization plate, wherein the sum of the height of the optical film, the height of the touch panel, and the height of the polarization plate is greater than the height of the touching control chip.

Based on the above, the touch display panel provided in the invention allows the distance between the conductive wire layouts of the touching control chip and the touch panel to become shorter by disposing both the touching control chip and the touch panel on the first surface of the color filter, thereby improving the signal transmission quality therebetween. Meanwhile, under the circumstances where the conductive wire layout is simplified, the area required for conductive wire layout can be reduced such that the manufacturing cost can be saved.

In order to make the aforementioned features and advantages of the invention more comprehensible, embodiments accompanying figures are described in detail below.

### BRIEF DESCRIPTION OF THE DRAWINGS

FIG. 1 is a schematic view illustrating a touch display panel of conventional techniques.

FIG. 2 is a schematic view illustrating a touch display panel in an embodiment of the invention.

FIG. 3A is a top view illustrating a touch display panel in an embodiment of the invention.

FIG. 3B is a side view illustrating a portion of the touch display panel in the embodiment in FIG. 3A.

FIG. 4A is a top view illustrating a touch display panel in another embodiment of the invention.

FIG. 4B is a side view illustrating a portion of the touch display panel in the embodiment of FIG. 4A.

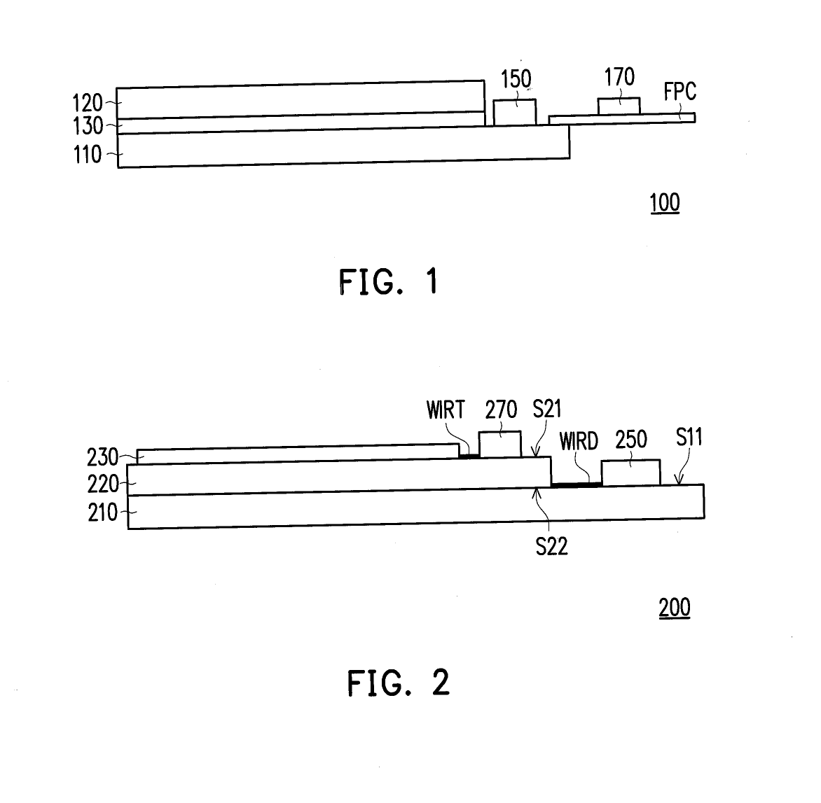

### DESCRIPTION OF EMBODIMENTS

Please refer to FIG. 2. FIG. 2 is a schematic view illustrating a touch display panel in the embodiments of the invention. A touch display panel 200 includes a display panel 210, a color filter 220, a touch panel 230, a display control chip 250 and a touching control chip 270. The display panel 210 has a surface S11. The color filter has a surface S21 and S22. The color filter 220 is disposed on the surface S11 of the display panel 210, and the surface S22 of the color filter 220 covers a partial area of the surface S11 of the display panel 210. The touch panel 230 covers a partial area of the surface S21 of the color filter 220. In addition, the touching control chip 270 is disposed in a partial area of the surface S21 in the color filter 220 not covered by the touch panel 230. The display control chip 250 is disposed in an area of the surface S11 of the display panel 210 not covered by the color filter 220.

The display panel 210 includes a plurality of display pixels, wherein each display pixel may include one or a plurality of thin film transistors. Each of the display pixels may be various kinds of display pixels such as a liquid display pixel, a light emitting diode display pixel or an organic light emitting display pixel. The display control chip 250 is electrically connected to the display pixels within the display panel 210 via a conductive wire WIRD disposed on the surface S11 of the display panel 210, thereby performing display-related controlling actions.

On the other hand, the touch panel 230 includes a plurality of touch detecting units. Since the touch panel 230 and the touching control chip 270 are both disposed on the same surface S21 of the color filter 220, the touching control chip 270 can be electrically connected to the touch detecting unit within the touch panel 230 via a conductive wire WIRT disposed in the surface S21 of the color filter 220, and the touching control action is performed to the touch detecting unit via the conductive wire WIRT.

Here, the conductive wire WIRT may be formed through the indium tin oxide (ITO) conductive wire disposed on the surface S21 of the color filter 220. The touching control chip 270 may be packed on the surface S21 of the color filter 220 in the manner of chip on glass (COG) and is electrically connected to the conductive wire WIRT.

The embodiment in FIG. 2 shows that, in the touch display panel 200, the conductive wire WIRT for the touching control chip 270 and the conductive wire WIRD for the display control chip 250 are respectively arranged on the surface S21 of the color filter 220 and the surface S11 of the display panel 210. That is to say, the conductive wire WIRT and the conductive wire WIRD are respectively and independently arranged on different surfaces and therefore the layout is easy to be made. Moreover, under the circumstances, the conductive wire WIRT and the conductive wire WIRD can be effectively shortened, and the noise interference to the data transmitted via the conductive wire WIRT and the conductive wire WIRD can be reduced, thereby improving the data transmission quality.

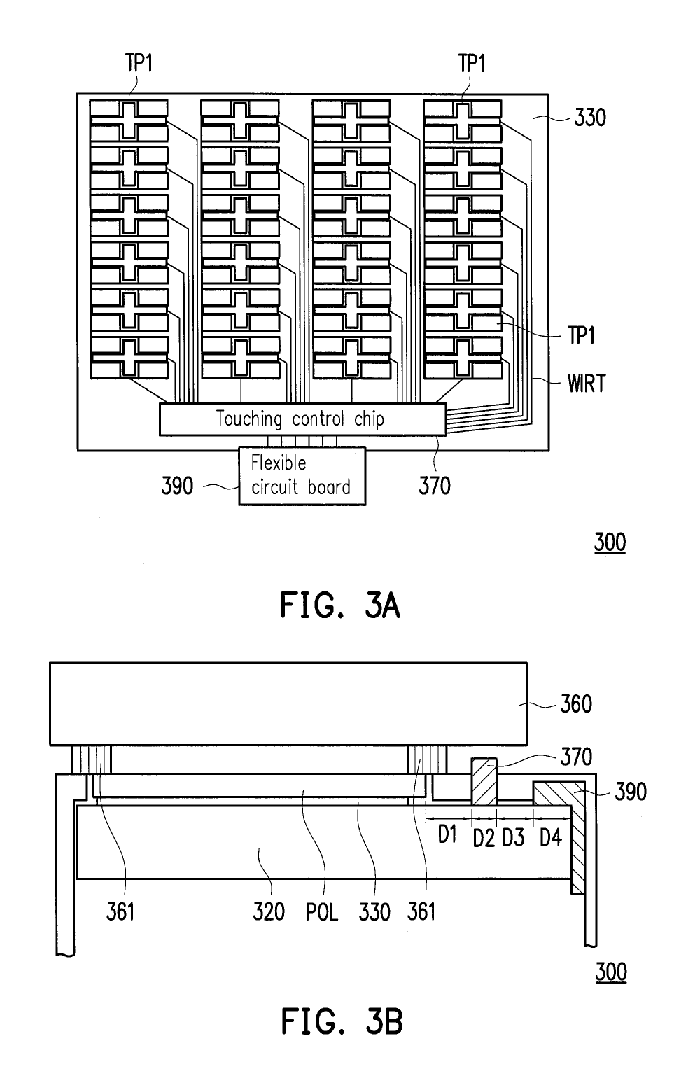

Please refer to FIGS. 3A and 3B. FIG. 3A is a top view illustrating a touch display panel in an embodiment of the invention. FIG. 3B is a side view illustrating a portion of the touch display panel in the embodiment in FIG. 3A. In FIG. 3A, the touch panel 330 of the touch display panel 300 includes a plurality of touch detecting units TPI. In the embodiment, the touch panel 330 includes, for example, a touch detecting unit TPI with a 5×4 single-layered and multi-touch ITO pattern. The touch panel 330 is coated to be disposed on the surface of the color filter of the touch display panel 300. The touching control chip 370 is disposed on the same surface as the color filter disposed for the touch panel 330. Meanwhile, the touching control chip 370 is electrically connected to the touch detecting unit TPI via the ITO conductive wire WIRT.

On the other hand, in the touch display panel 300, the flexible circuit board 390 is also disposed on the surface of the color filter of the touch display panel 300. The flexible circuit board 390 is electrically connected to the touching control chip 370 to transmit a signal to an outer printed circuit board.

In FIG. 3B, the touch display panel 300 includes a color filter 320, a touch panel 330, a touching control chip 370, a polarization plate POL, a plurality of supporting posts 361, and a glass cover 360. The touch panel 330 and the touching control chip 370 are disposed on the same surface of the color filter 320, and the polarization plate POL covers the touch panel 330. In addition, the supporting post 361 is disposed on the polarization plate POL; the glass cover 360 is supported by the supporting post 361 to cover the polarization plate POL. Supported by the supporting post 361, a space is formed between the glass cover 360 and the polarization plate POL.

It should be noted that the glass cover 360 covers the polarization plate POL and the touching control chip 370 both; accordingly, the sum of the height of each of the supporting posts 361, the height of the touch panel 330, and the height of the polarization plate POL is greater than the height of the touching control chip 370.

Moreover, in the embodiment, the shortest distance D1 between the touching control chip 370 and the polarization plate POL may be 0.3 millimeters. The width D2 of the touching control chip 370 may be 0.1 millimeters; the shortest distance D3 between the touching control chip 370 and the flexible circuit board 390 may be 0.3 millimeters. A side length D4 of the flexible circuit board 390 covering the color filter 320 may be 0.3 millimeters.

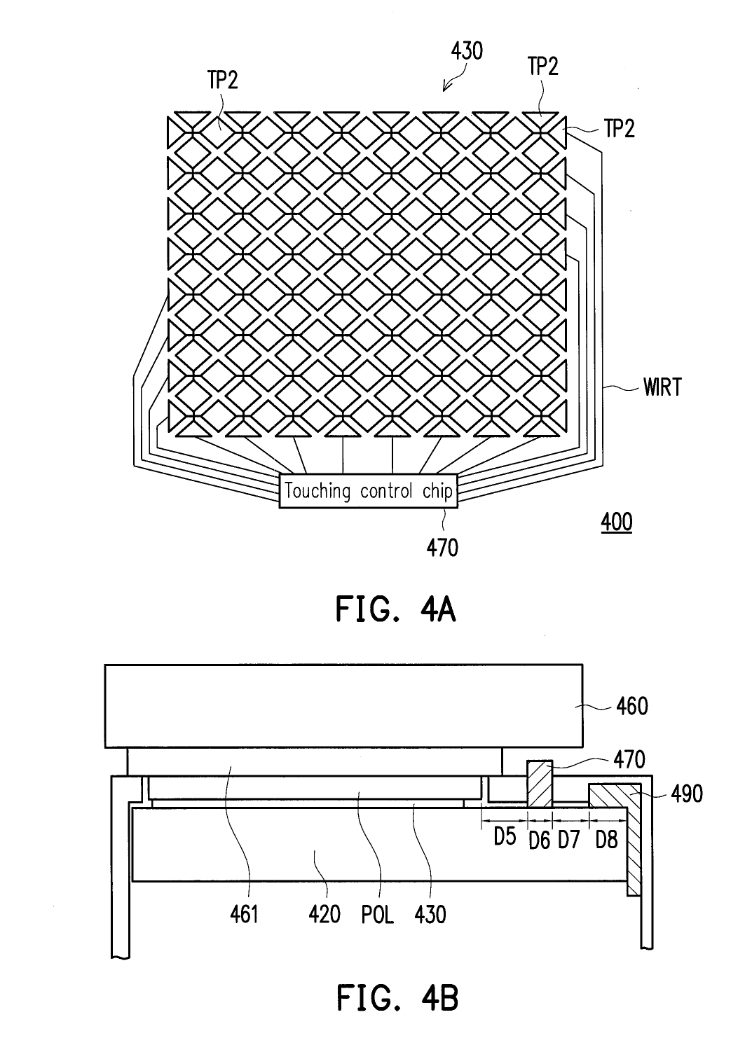

Please refer to FIGS. 4A and 4B. FIG. 4A is a top view illustrating a touch display panel in another embodiment of the invention. FIG. 4B is a side view illustrating a portion of the touch display panel in the embodiment of FIG. 4A. In FIG. 4A, a touch panel 430 of the touch display panel 400 includes a plurality of touch detecting units TP2. In the embodiment, the touch panel 430 includes, for example, a touch detecting unit TP2 with an 8×8 rhombus ITO pattern. The touch panel 430 is coated to be disposed on the surface of the color filter of the touch display panel 400. The touching control chip 470 is disposed on the same surface as the color filter disposed for the touch panel 430. Also, the touching control chip 470 is electrically connected to the touch detecting unit TP2 thorough the ITO conductive wire WIRT.

In FIG. 4B, the touch display panel 400 includes a color filter 420, a touch panel 430, a touching control chip 470, a polarization plate POL, an optical film 461, and a glass cover 460. The touch panel 430 and the touching control chip 470 are disposed on the same surface of the color filter 420; the polarization plate POL covers the touch panel 430. Meanwhile, the optical film 461 is disposed in and covers the polarization plate POL, and the glass cover 460 covers the optical film 461.

It should be noted that the glass cover 460 covers the polarization plate POL and the touching control chip 470 both. Accordingly, the sum of the height of the optical film 461, the height of the touch panel 430, and the height of the polarization plate POL is greater than the height of the touching control chip 470.

Furthermore, in the embodiment, the shortest distance D5 between the touching control chip 470 and the polarization plate POL may be 0.2 millimeters; the width D6 of the touching control chip 470 may be 0.1 millimeters. The shortest distance D7 between the touching control chip 470 and the flexible circuit board 490 may be 0.2 millimeters; a side length D8 of the flexible circuit board 490 covering the color filter 420 may be 0.3 millimeters.

In summary, in the invention, the touch panel and the touching control chip are disposed on the same surface of the color filter. Accordingly, the layout complexity of the conductive wires used by the touching control chip for transmitting the data for controlling the touch panel to perform the touching action will be significantly reduced, and the length of the conductive wire can also be decreased to a large extent as well, thereby reducing the possibility that the data is interfered by noise and improving the reliability of data transmitted for performing the touching action. Moreover, the layout area for the conductive wire can also be reduced so that the cost of the products can be lowered.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A touch display panel, comprising:
a display panel having a first surface;
a color filter having a first surface and a second surface, the color filter disposed on the first surface of the display panel, and the second surface of the color filter covering a portion of the first surface of the display panel;
a touch panel covering a portion of the first surface of a portion of the color filter; and
a touching control chip disposed on a portion of the first surface of the color filter not covered by the touch panel.

2. The touch display panel according to claim 1, further comprising:
a display driving chip disposed on a portion of the first surface of the display panel not covered by the color filter.

3. The touch display panel according to claim 1, wherein the display panel comprises a plurality of display pixels, wherein the display driving chip is electrically connected to the display pixels.

4. The touch display panel according to claim 1, wherein the touch panel comprises a plurality of touch detecting units connected to the touching control chip via conductive wires.

5. The touch display panel according to claim 4, wherein the conductive wires are disposed on the first surface of the color filter, and the conductive wires are indium tin oxide conductive wires.

6. The touch display panel according to claim 4, wherein the touching control chip is disposed on the color filter in the manner of chip on glass.

7. The touch display panel according to claim 1, further comprising:
a glass cover disposed on the touch panel and covers the touch panel as well as the touching control chip.

8. The touch display panel according to claim 7, further comprising:
a polarization plate disposed between the glass cover and the touch plate and covers the touch panel; and
a plurality of supporting posts disposed between the glass cover and the polarization plate for supporting the glass cover,
wherein a sum of a height of each of the supporting posts, a height of the touch panel, and a height of the polarization plate is greater than a height of the touching control chip.

9. The touch display panel according to claim 7, further comprising:
a polarization plate disposed between the glass cover and the touch panel and covers the touch plate; and
an optical film disposed between the glass cover and the polarization plate,
wherein a sum of a height of the optical film, a height of the touch panel, and a height of the polarization plate is greater than a height of the touching control chip.
